(19) United States
(12) Patent Application Publication
(10) Pub. No.: US 2025/0199754 A1
(43) Pub. Date: Jun. 19, 2025

(54) VOICE GUIDANCE APPARATUS, VEHICLE, AND NON-TRANSITORY COMPUTER READABLE MEDIUM

(71) Applicant: TOYOTA JIDOSHA KABUSHIKI KAISHA, Toyota-shi (JP)

(72) Inventors: Yuki TATSUMOTO, Seto-shi (JP); Josuke YAMANE, Nagoya-shi (JP); Hirotaka NOGAMI, Nisshin-shi (JP); Kazuya NISHIMURA, Anjo-shi (JP); Takumi FUKUNAGA, Iwakura-shi (JP)

(73) Assignee: TOYOTA JIDOSHA KABUSHIKI KAISHA, Toyota-shi (JP)

(21) Appl. No.: 18/974,792

(22) Filed: Dec. 10, 2024

(30) Foreign Application Priority Data
Dec. 15, 2023 (JP) 2023-212502

(51) Int. Cl. G06F 3/16; B60W 50/00; B60W 50/14

(52) U.S. Cl. CPC G06F 3/165; B60W 50/14; B60W 2050/0083

(57) ABSTRACT

A voice guidance apparatus includes a controller configured to accept a setting for volume of voice guidance to be output in a vehicle for each volume level of a noise that may be detected in the vehicle, and adjust, upon detecting a noise in the vehicle when outputting the voice guidance, the volume of the voice guidance to set volume corresponding to a volume level of the detected noise.

### CROSS-REFERENCE TO RELATED APPLICATION

This application claims priority to Japanese Patent Application No. 2023-212502 filed on Dec. 15, 2023, the entire contents of which are incorporated herein by reference.

### TECHNICAL FIELD

The present disclosure relates to a voice guidance apparatus, a vehicle, and a program.

### BACKGROUND

Patent Literature (PTL) 1 discloses an audio system for automobile that automatically adjusts the volume according to the driving conditions of the vehicle.

### CITATION LIST

### Patent Literature

PTL 1: JP H11-184475 A

### SUMMARY

Generally, the volume of voice guidance in the vehicle can be set by the user on the settings screen. However, in a quiet environment, such as while the vehicle is stopped, the volume may be set without considering the effects of various noises that may occur while the vehicle is in motion, and as a result, the voice guidance may be difficult to hear while the vehicle is in motion.

It would be helpful to enable the user to set the volume of the voice guidance in the vehicle taking into account the effects of noises with different volume levels.

A voice guidance apparatus according to the present disclosure includes a controller configured to:
accept a setting for volume of voice guidance to be output in a vehicle for each volume level of a noise that may be detected in the vehicle; and
adjust, upon detecting a noise in the vehicle when outputting the voice guidance, the volume of the voice guidance to set volume corresponding to a volume level of the detected noise.

A program according to the present disclosure is configured to cause a computer to execute operations, the operations including:
accepting a setting for volume of voice guidance to be output in a vehicle for each volume level of a noise that may be detected in the vehicle; and
adjusting, upon detecting a noise in the vehicle when outputting the voice guidance, the volume of the voice guidance to set volume corresponding to a volume level of the detected noise.

According to the present disclosure, the user can set the volume of the voice guidance in the vehicle taking into account the effects of noises with different volume levels.

### BRIEF DESCRIPTION OF THE DRAWINGS

In the accompanying drawings:

FIG. 1 is a diagram illustrating an example of a vehicle including a voice guidance apparatus according to an embodiment of the present disclosure;

FIG. 2 is a table illustrating an example of setting information stored in the voice guidance apparatus according to the embodiment of the present disclosure;

FIG. 3 is a block diagram illustrating a configuration of the voice guidance apparatus according to the embodiment of the present disclosure;

FIG. 4 is a flowchart illustrating operations of the voice guidance apparatus according to the embodiment of the present disclosure that are related to the settings for the volume of voice guidance; and

FIG. 5 is a flowchart illustrating operations of the voice guidance apparatus according to the embodiment of the present disclosure that are related to the output of the voice guidance.

### DETAILED DESCRIPTION

An embodiment of the present disclosure will be described below, with reference to the drawings.

In the drawings, the same or corresponding portions are denoted by the same reference numerals. In the descriptions of the present embodiment, detailed descriptions of the same or corresponding portions are omitted or simplified, as appropriate.

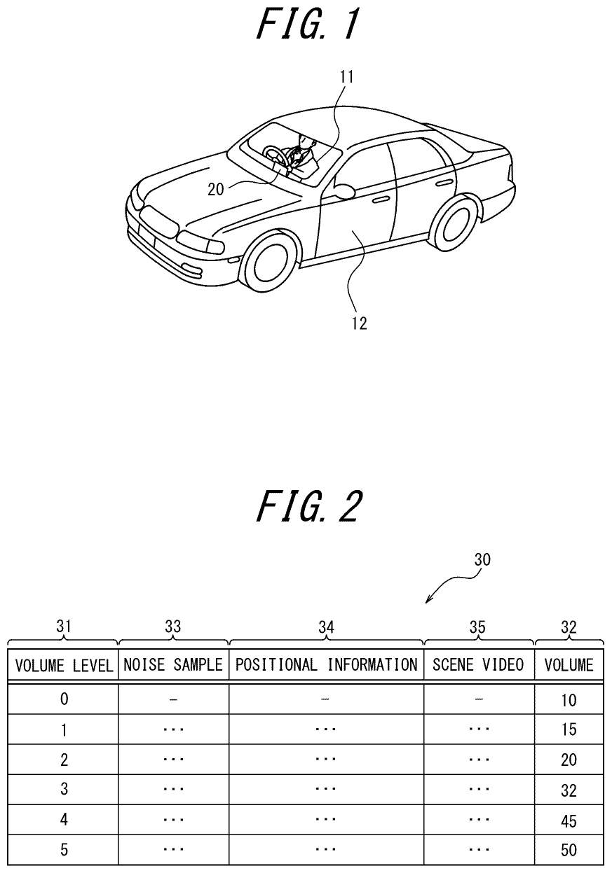

An outline of the present embodiment will be described with reference to FIGS. 1 and 2.

The voice guidance apparatus 20 is a computer with voice guidance capability. In the present embodiment, the voice guidance apparatus 20 is an in-vehicle device, such as a navigation device, installed in a vehicle 12. In other words, the voice guidance apparatus 20 is installed in the vehicle 12, as illustrated in FIG. 1. As a variation, the voice guidance apparatus 20 may be a mobile device owned by the user 11, such as a mobile phone, smartphone, or tablet. In other words, the voice guidance apparatus 20 may be brought into the vehicle 12 by the user 11 instead of being provided in the vehicle 12.

The vehicle 12 is, for example, any type of automobile such as a gasoline vehicle, a diesel vehicle, a hydrogen vehicle, an HEV, a PHEV, a BEV, or an FCEV. The term “HEV” is an abbreviation of hybrid electric vehicle. The term “PHEV” is an abbreviation of plug-in hybrid electric vehicle. The term “BEV” is an abbreviation of battery electric vehicle. The term “FCEV” is an abbreviation of fuel cell electric vehicle. The vehicle 12 may be driven by the user 11, or the driving may be automated at any level. The automation level is, for example, any one of Level 1 to Level 5 according to the level classification defined by SAE. The name “SAE” is an abbreviation of Society of Automotive Engineers. The vehicle 12 may be a MaaS-dedicated vehicle. The term “MaaS” is an abbreviation of Mobility as a Service.

The voice guidance apparatus 20 determines a plurality of volume levels 31 for a first noise that may be detected in the vehicle 12. The voice guidance apparatus 20 accepts a setting for the volume 32 of the voice guidance to be played in the vehicle 12 for each volume level 31 of the first noise. The voice guidance apparatus 20 stores the setting information 30 including the set volume 32 in correspondence with each volume level 31 of the first noise. When the voice guidance apparatus 20 plays the voice guidance in the vehicle 12, it plays the voice guidance at the volume 32 corresponding to a volume level 31 equal to the volume level of the second noise actually detected in the vehicle 12.

According to the present embodiment, the volume 32 of the voice guidance played in the vehicle 12 can be set for each volume level 31 of the first noise that may be detected in the vehicle 12. Thus, the user 11 can set the volume 32 of the voice guidance while imagining the effect of noise.

If the user 11 sets the volume 32 of the voice guidance for some volume levels 31 of the first noise, the voice guidance apparatus 20 may automatically set the volume 32 of the voice guidance for the remaining volume levels 31 of the first noise by interpolation. In the example illustrated in FIG. 2, assume that volume 32 is manually set to “10”, “20”, and “45” for the three volume levels 31 of “0”, “2”, and “4” out of “0” through “5”, respectively. Therefore, for the volume level 31 of “1”, the volume 32 is automatically set to “15”, a value halfway between the volume 32 corresponding to the two volume levels 31 of “0” and “2”. For the volume level 31 of “3”, the volume 32 is automatically set to a value of “32”, which is halfway between the volume 32 corresponding to the two volume levels 31 of “2” and “4”. As a variation, the volume 32 corresponding to the volume level 31 of “3” may be automatically set to “33”, taking into account the decimal point. For the volume level 31 of “5”, volume 32 is automatically set to the upper limit value of “50”. As a variation, the volume 32 corresponding to the volume level 31 of “5” may be automatically set to “58” to match the change in volume 32 corresponding to the two volume levels 31 of “3” and “4” if there is no upper limit or it is negligible.

The voice guidance apparatus 20 may store a sample of the first noise as the noise sample 33, corresponding to each volume level 31 of the first noise. The voice guidance apparatus 20 may then accept the setting for the volume 32 corresponding to the same volume level 31 while playing the noise sample 33 corresponding to the volume level 31 specified by the user 11 when accepting the setting for the volume 32 of the voice guidance.

The voice guidance apparatus 20 may store the location of the vehicle 12 at the time of detection of that third noise as positional information 34, corresponding to a volume level 31 equal to the volume level of the third noise that was actually detected in the vehicle 12 in the past. The voice guidance apparatus 20 may then present positional information 34 corresponding to the volume level 31 of the noise sample 33 being played to the user 11 when accepting the setting for the volume 32 of the voice guidance. For example, the voice guidance apparatus 20 may display on screen or output audibly the message “The system is playing noise at the same volume level as when you passed through . . . ”.

The voice guidance apparatus 20 may store as a scene video 35 the video of the outside of the vehicle 12 at the time of detection of that third noise, corresponding to a volume level 31 equal to the volume level of the third noise that was actually detected in the vehicle 12 in the past. The voice guidance apparatus 20 may then present a scene video 35 corresponding to the volume level 31 of the noise sample 33 being played to the user 11 when accepting the setting for the volume 32 of the voice guidance. For example, the voice guidance apparatus 20 may play the driving recorder video taken when it detects a third noise at the same volume level as the noise sample 33 being played.

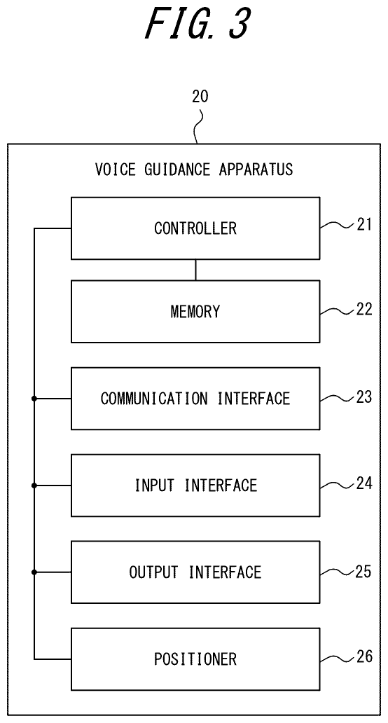

A configuration of the voice guidance apparatus 20 according to the present embodiment will be described with reference to FIG. 3.

The voice guidance apparatus 20 includes a controller 21, a memory 22, a communication interface 23, an input interface 24, an output interface 25, and a positioner 26.

The controller 21 includes at least one processor, at least one programmable circuit, at least one dedicated circuit, or any combination thereof. The processor is a general purpose processor such as a CPU or a GPU, or a dedicated processor that is dedicated to specific processing. The term “CPU” is an abbreviation of central processing unit. The term “GPU” is an abbreviation of graphics processing unit. The programmable circuit is, for example, an FPGA. The term “FPGA” is an abbreviation of field-programmable gate array. The dedicated circuit is, for example, an ASIC. The term “ASIC” is an abbreviation of application specific integrated circuit. The controller 21 executes processes related to the operations of the voice guidance apparatus 20 while controlling the components of the voice guidance apparatus 20.

The memory 22 includes at least one semiconductor memory, at least one magnetic memory, at least one optical memory, or any combination thereof. The semiconductor memory is, for example, RAM, ROM, or flash memory. The term “RAM” is an abbreviation of random access memory. The term “ROM” is an abbreviation of read only memory. The RAM is, for example, SRAM or DRAM. The term “SRAM” is an abbreviation of static random access memory. The term “DRAM” is an abbreviation of dynamic random access memory. The ROM is, for example, EEPROM. The term “EEPROM” is an abbreviation of electrically erasable programmable read only memory. The flash memory is, for example, SSD. The term “SSD” is an abbreviation of solid-state drive. The magnetic memory is, for example, HDD. The term “HDD” is an abbreviation of hard disk drive. The memory 22 functions as, for example, a main memory, an auxiliary memory, or a cache memory. The memory 22 stores information to be used for the operations of the voice guidance apparatus 20 and information obtained by the operations of the voice guidance apparatus 20. For example, the memory 22 stores setting information 30. The setting information 30 includes the set volume 32 for each volume level 31. The setting information 30 may further include a noise sample 33, positional information 34, and a scene video 35 for each volume level 31, as illustrated in FIG. 2.

The communication interface 23 includes at least one communication module. The communication module is, for example, a module compatible with a mobile communication standard such as LTE, the 4G standard, or the 5G standard, or a wireless LAN communication standard such as IEEE 802.11. The term “LTE” is an abbreviation of Long Term Evolution. The term “4G” is an abbreviation of 4th generation. The term “5G” is an abbreviation of 5th generation. The name “IEEE” is an abbreviation of Institute of Electrical and Electronics Engineers. The communication interface 23 may communicate with an external server, such as a cloud server, via a network such as the Internet. The communication interface 23 receives information to be used for the operations of the voice guidance apparatus 20 and transmits information obtained by the operations of the voice guidance apparatus 20.

The input interface 24 includes at least one input device. The input device is, for example, a physical key, a capacitive key, a pointing device, a touch screen integrally provided with a display, a visible light camera, a depth camera, a LiDAR sensor, or a microphone. The term “LiDAR” is an abbreviation of light detection and ranging. The input interface 24 accepts an operation for inputting information to be used for the operations of the voice guidance apparatus 20. Instead of being included in the voice guidance apparatus 20, the input interface 24 may be connected to the voice guidance apparatus 20 as an external input device. As an interface for connection, an interface compliant with a standard such as USB, HDMI® (HDMI is a registered trademark in Japan, other countries, or both), or Bluetooth® (Bluetooth is a registered trademark in Japan, other countries, or both) can be used. The term “USB” is an abbreviation of Universal Serial Bus. The term “HDMI®” is an abbreviation of High-Definition Multimedia Interface.

The output interface 25 includes at least one output device. The output device is, for example, a display or a speaker. The display is, for example, an LCD or an organic EL display. The term “LCD” is an abbreviation of liquid crystal display. The term “EL” is an abbreviation of electro luminescent. The output interface 25 outputs information obtained by the operations of the voice guidance apparatus 20. The output interface 25, instead of being included in the voice guidance apparatus 20, may be connected to the voice guidance apparatus 20 as an external output device such as a display audio. As an interface for connection, an interface compliant with a standard such as USB, HDMI®, or Bluetooth® can be used.

The positioner 26 includes at least one GNSS receiver. The term “GNSS” is an abbreviation of global navigation satellite system. GNSS is, for example, GPS, QZSS, BDS, GLONASS, or Galileo. The term “GPS” is an abbreviation of Global Positioning System. The term “QZSS” is an abbreviation of Quasi-Zenith Satellite System. QZSS satellites are called quasi-zenith satellites. The term “BDS” is an abbreviation of BeiDou Navigation Satellite System. The term “GLONASS” is an abbreviation of Global Navigation Satellite System. The positioner 26 measures the position of the voice guidance apparatus 20.

The functions of the voice guidance apparatus 20 are realized by execution of a program according to the present embodiment by a processor serving as the controller 21. That is, the functions of the voice guidance apparatus 20 are realized by software. The program causes a computer to execute the operations of the voice guidance apparatus 20, thereby causing the computer to function as the voice guidance apparatus 20. That is, the computer executes the operations of the voice guidance apparatus 20 in accordance with the program to thereby function as the voice guidance apparatus 20.

The program can be stored on a non-transitory computer readable medium. The non-transitory computer readable medium is, for example, flash memory, a magnetic recording device, an optical disc, a magneto-optical recording medium, or ROM. The program is distributed, for example, by selling, transferring, or lending a portable medium such as an SD card, a DVD, or a CD-ROM on which the program is stored. The term “SD” is an abbreviation of Secure Digital. The term “DVD” is an abbreviation of digital versatile disc. The term “CD-ROM” is an abbreviation of compact disc read only memory. The program may be distributed by storing the program in a storage of a server and transferring the program from the server to another computer. The program may be provided as a program product.

For example, the computer temporarily stores, in a main memory, the program stored in the portable medium or the program transferred from the server. Then, the computer reads the program stored in the main memory using the processor, and executes processes in accordance with the read program using the processor. The computer may read the program directly from the portable medium, and execute processes in accordance with the program. The computer may, each time a program is transferred from the server to the computer, sequentially execute processes in accordance with the received program. Instead of transferring the program from the server to the computer, processes may be executed by a so-called ASP type service that realizes functions only by execution instructions and result acquisitions. The term “ASP” is an abbreviation of application service provider. The program encompasses information that is to be used for processing by an electronic computer and is thus equivalent to a program. For example, data that is not a direct command to a computer but has a property that regulates processing of the computer is “equivalent to a program” in this context.

Some or all of the functions of the voice guidance apparatus 20 may be realized by a programmable circuit or a dedicated circuit serving as the controller 21. That is, some or all of the functions of the voice guidance apparatus 20 may be realized by hardware.

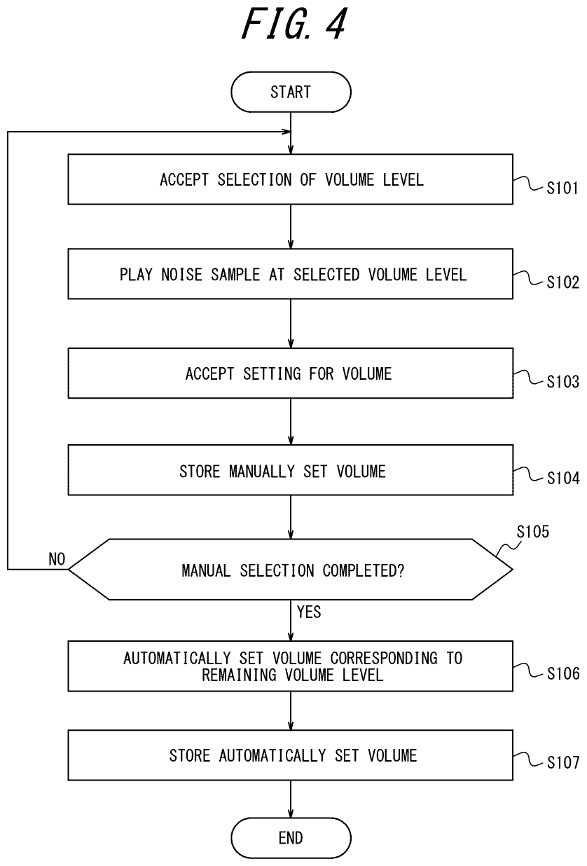

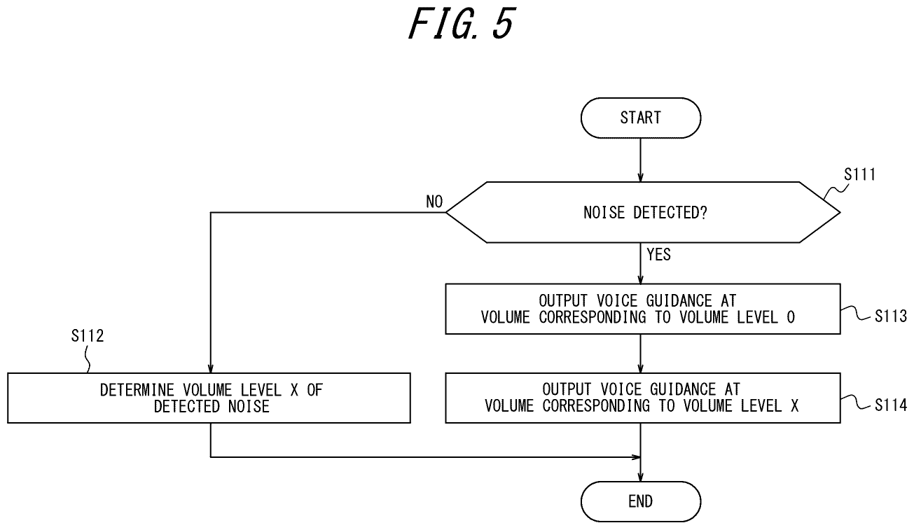

Operations of the voice guidance apparatus 20 according to the present embodiment will be described with reference to FIGS. 4 and 5. The operations described below correspond to a voice guidance method according to the present embodiment. In other words, the voice guidance method for the present embodiment includes steps S101 to S107 illustrated in FIG. 4 and steps S111 to S114 illustrated in FIG. 5.

In the flow illustrated in FIG. 4, the controller 21 accepts a setting for the volume 32 of voice guidance to be output in the vehicle 12 for each volume level 31 of a noise that may be detected in the vehicle 12.

Specifically, in S101, the controller 21 accepts the selection of one volume level 31 from among the plurality of volume levels 31 via the input interface 24, such as a touch screen or microphone. In S102, the controller 21 retrieves noise samples 33 at the volume level 31 selected by the user 11 in S101 from the memory 22. The controller 21 plays the acquired noise samples 33 through the output interface 25, such as a speaker. In S103, the controller 21 accepts the setting for volume 32 corresponding to the volume level 31 selected by the user 11 in S101 via the input interface 24 such as touch screen or microphone. In S104, the controller 21 stores the volume 32 manually set by the user 11 in S103 in the memory 22 in association with the volume level 31 selected by the user 11 in S101. In S105, the controller 21 determines whether the manual setting for the volume 32 corresponding to two or more desired volume levels 31 among the plurality of volume levels 31 is completed. If, as in the example illustrated in FIG. 2, the volume 32 corresponding to the three volume levels 31 of “0”, “2”, and “4” out of “0” to “5” are subject to manual setting, then the controller 21 determines whether the manual setting for the volume 32 corresponding to those three volume levels 31 is complete.

If one manual setting for volume 32 corresponding to two or more desired volume levels 31 has not been completed, in S101 to S104, the controller 21 accepts the setting for the volume 32 that has not been completed.

On the other hand, if all manual settings for volume 32 corresponding to two or more desired volume levels 31 have been completed, in S106, the controller 21 automatically sets volume 32 corresponding to the remaining volume levels 31 among the plurality of volume levels 31 based on those completed settings for the volume 32. If, as in the example illustrated in FIG. 2, the volume 32 corresponding to the three volume levels 31 of “1”, “3”, and “5” out of “0” to “5” is the target of automatic setting, then the controller 21, based on the setting for the volume 32 corresponding to the three volume levels 31 of “0”, “2”, and “4”, “1”, “3”, and “5”, the controller 21 automatically sets the volume 32 corresponding to the three volume levels 31 of “1”, “3”, and “5” by interpolation or other calculation methods. Then, in S107, the controller 21 stores the volume 32 automatically set in S106 in memory 22 in association with the remaining volume level 31.

As described above, in S103, the controller 21 accepts the setting for the volume 32 corresponding to a specific volume level 31 while playing a noise sample 33 at the specific volume level 31. However, as a variation, the controller 21 may accept a setting for volume 32 corresponding to the specific volume level 31 without playing the noise sample 33. In other words, the step S102 may be omitted. Alternatively, as another variation, the controller 21 may play a noise sample 33 at a specific volume level 31 and present positional information 34 corresponding to the specific volume level 31 to the user 11 while accepting a setting for volume 32 corresponding to the specific volume level 31. That is, in S102, the controller 21 may retrieve the positional information 34 corresponding to the volume level 31 of the noise sample 33 to be played from the memory 22 and output it via the output interface 25 such as a display or speaker. Alternatively, as yet another variation, the controller 21 may play a noise sample 33 at a specific volume level 31 and accept a setting for volume 32 corresponding to the specific volume level 31 while playing a scene video 35 corresponding to the specific volume level 31. In other words, in S102, the controller 21 may retrieve the scene video 35 corresponding to the volume level 31 of the noise sample 33 to be played back from the memory 22 and play it back via the output interface 25 such as a display.

As described above, in S105, the controller 21 determines whether the manual setting for the volume 32 corresponding to two or more desired volume levels 31 among the plurality of volume levels 31 is complete. However, as a variation, the controller 21 may determine whether the manual setting for the volume 32 corresponding to all of the plurality of volume levels 31 is complete. In other words, steps S106 and S107 may be omitted.

In the flow illustrated in FIG. 5, the controller 21 outputs voice guidance. If the controller 21 adjusts, upon detecting a noise in the vehicle 12 when outputting the voice guidance, the volume of the voice guidance to the set volume 32 corresponding to the volume level 31 of the detected noise.

Specifically, in S11, the controller 21 determines whether or not some noise, such as noise emitted by the vehicle 12 itself as it travels or noise entering from outside the vehicle 12, is detected via the input interface 24, such as a microphone.

If no noise is detected, in S112, the controller 21 outputs voice guidance at volume 32 stored in memory 22 corresponding to the lowest volume level 31, via the output interface 25 such as a speaker. In the example illustrated in FIG. 2, the controller 21 adjusts the volume of the voice guidance to 32, or “10”, corresponding to the volume level 31 of “0”. The controller 21 may notify the user 11 of the current noise volume level “0” via the output interface 25, such as a display or speaker.

On the other hand, if noise is detected, in S113, the controller 21 determines the volume level of the noise detected in S111. Then, in S114, the controller 21 outputs the voice guidance at the volume 32 stored in the memory 22, which is associated with the volume level 31 equal to the volume level determined in S113, through the output interface 25 such as a speaker. In the example illustrated in FIG. 2, if the volume level of the detected noise matches the volume level 31 of “3”, then the controller 21 adjusts the volume of the voice guidance to the volume 32 corresponding to the volume level 31 of “3”. The controller 21 may notify the user 11 of the current noise volume level of “3” via the output interface 25, such as a display or speaker.

The present disclosure is not limited to the embodiment described above. For example, two or more blocks described in the block diagram may be integrated, or a block may be divided. Instead of executing two or more steps described in the flowchart in chronological order in accordance with the description, the steps may be executed in parallel or in a different order according to the processing capability of the apparatus that executes each step, or as required. Other modifications can be made without departing from the spirit of the present disclosure.

1. A voice guidance apparatus comprising a controller configured to:
accept a setting for volume of voice guidance to be output in a vehicle for each volume level of a noise that may be detected in the vehicle; and
adjust, upon detecting a noise in the vehicle when outputting the voice guidance, the volume of the voice guidance to set volume corresponding to a volume level of the detected noise.

2. The voice guidance apparatus according to claim 1, wherein the controller is configured to:
accept settings for volume corresponding to two or more volume levels among a plurality of volume levels; and
automatically set volume corresponding to a remaining volume level among the plurality of volume levels based on the settings for the volume corresponding to the two or more volume levels.

3. The voice guidance apparatus according to claim 1, wherein the controller is configured to accept a setting for volume corresponding to a specific volume level while playing a noise sample at the specific volume level.

4. A vehicle comprising the voice guidance apparatus according to claim 1.

5. A non-transitory computer readable medium storing a program configured to cause a computer to execute operations, the operations comprising:
accepting a setting for volume of voice guidance to be output in a vehicle for each volume level of a noise that may be detected in the vehicle; and
adjusting, upon detecting a noise in the vehicle when outputting the voice guidance, the volume of the voice guidance to set volume corresponding to a volume level of the detected noise.
